(19) United States
(12) Patent Application Publication
(10) Pub. No.: US 2011/0083038 A1
(43) Pub. Date: Apr. 7, 2011

(54) COMMUNICATION SYSTEM AND A METHOD AND CALL PROCESSOR FOR USE IN THE SYSTEM

(75) Inventor: Keld Andersen, Ringsted (DK)

(73) Assignee: MOTOROLA, INC., Schaumburg, IL (US)

(21) Appl. No.: 12/996,826

(22) PCT Filed: Jun. 18, 2009
(86) PCT No.: PCT/US09/47746

§ 371 Date: Dec. 8, 2010

(30) Foreign Application Priority Data
Jun. 27, 2008 (GB) 0811787.1

(51) Int. Cl. G06F 11/20

(52) U.S. Cl. 714/4.12; 714/E11.071

(57) ABSTRACT

A communication system (100) including a first call processor (101), a second call processor (102) operable to serve as a backup to the first call processor in the event of a failure condition of the first call processor, and a third call processor (103) operable to communicate with the first call processor to establish a call on behalf of a client terminal served by the third call processor, wherein the second call processor is operable to receive from the third call processor status information indicating whether the first call processor is alive and the second call processor is operable to use the status information from the third call processor to deduce whether the first call processor is alive.

Also described is a method of operation (200, 300) and a call processor (101, 102) for use in the system (100).

### FIELD OF THE INVENTION

This invention relates to a communication system and a method and a call processor for use in the system. In particular, the invention relates to a mobile communication system in which a call processor is able to detect a failure condition of, and provide backup to, another call processor in the system.

### BACKGROUND OF THE INVENTION

Communication systems employ call processors of various kinds which operate to establish a communication path between a calling client terminal and one or more receiving terminals. In this specification the expressions ‘call’ and ‘calling’ refer not only to communication of speech information but also to communication of other kinds of user communicated information such as alphanumeric, picture or video data. For example, in a mobile communication system, call processing is carried out by a network of base stations, each serving mobile stations in a given cell, and by call processing servers associated with controllers which control operation of the various base stations. For example, in a TETRA system, i.e. a system operating in accordance with the TETRA standard protocols defined by ETSI (The European Telecommunications Standards Institute), the controllers which include call processing servers are zone controllers. Each of such controllers may be associated with a particular zone of the system and may include a database which records data relating to mobility of mobile stations in or associated with the zone.

Since a call processor carries out an important function in a communication system it is usual to provide for an active call processor a backup call processor which can take over the function of the active call processor in the event that the active call processor has a failure. The active call processor and the backup call processor may have a direct link between them which allows status messages to be sent directly and regularly between them. The backup call processor may be able to deduce that the active call processor has a failure if it receives no expected status message from the active call processor. When the backup call processor makes such a deduction, it switches state in response to become active in place of the active call processor.

If there is a failure of the link between the active call processor and the backup call processor, the failure may cause the backup call processor to make the same deduction as in the situation in which the active call processor fails. Thus, if the link but not the active call processor has failed, the backup call processor may make a false failure detection and become active. In consequence, a highly undesirable situation is produced in which both call processors become active at the same time with respect to establishing the same calls. Such a condition may produce confusion and malfunction within the system.

### SUMMARY OF THE INVENTION

In accordance with a first aspect of the present invention there is provided a communication system as defined in claim 1 of the accompanying claims.

In accordance with a second aspect of the present invention there is provided a method as defined in claim 17 of the accompanying claims.

In accordance with a third aspect of the present invention there is provided a call processor as defined in claim 22 of the accompanying claims.

Further features of the invention are as defined in the accompanying dependent claims and as disclosed in the embodiments to be described.

Embodiments of the present invention will be described with reference to the accompanying drawings.

### BRIEF DESCRIPTION OF THE DRAWINGS

The accompanying drawings, in which like reference numerals refer to identical or functionally similar elements throughout the different drawings and which together with the detailed description later are incorporated in and form part of the specification, serve to illustrate various embodiments and to explain various principles and examples of the present invention. In the accompanying drawings:

FIG. 1 is a block schematic diagram of a mobile communication system including an arrangement of call processors operating in accordance with an embodiment of the invention.

FIG. 2 is a flow chart of a method of operation in the system of FIG. 1.

FIG. 3 is a flow chart of a further method of operation in the system of FIG. 1.

### DESCRIPTION OF EMBODIMENTS OF THE INVENTION

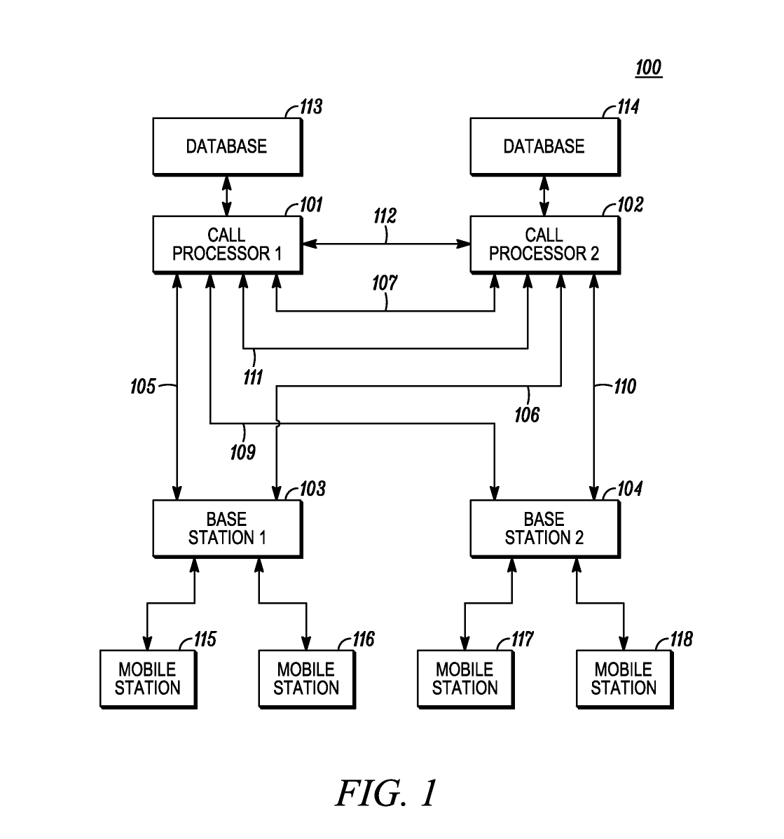

FIG. 1 shows a communication system 100 including an arrangement of call processors. The system 100 may be a mobile communication system. Illustratively, but not exclusively, the system 100 may be a TETRA system. For simplicity and clarity, various other components of the system 100 which will be familiar to persons skilled in the art are not shown in FIG. 1. The system 100 includes in its infrastructure a call processor 1 101 and a call processor 2 102 which work together as a pair. Each of the call processor 1 101 and the call processor 2 102 may have a fixed location. The location of the call processor 1 101 may be different from that of the call processor 2 102, i.e. the call processor 1 101 and the call processor 2 102 may have a geographical separation. The call processor 1 101 and the call processor 2 102 may be call processing servers. Where the system 100 is a TETRA system, the call processing servers may be zonal call processing servers of one or more zone controllers, e.g. working together in a given geographical zone of the system 100. Each of the call processors may be associated with a database containing data relating to mobility of mobile stations operating in the system 100. Thus, the call processor 1 101 is associated with and is operably coupled to a database 113 which operates in a known manner, and the call processor 2 is associated with and is operably coupled to a database 114 which operates in a known manner. The databases 113 and 114 may be replicas of one another. Replication of the databases 113 and 114 may be maintained in a known manner.

Normally, one of the call processor 1 101 and the call processor 2 102 is active, to serve in certain specified call processing functions using its associated database, and the other is a backup call processor ready to serve in place of the active call processor in the event that the active call processor fails.

The backup call processor may be held in a standby state to serve in place of the active call processor if the active call processor fails. Alternatively, the backup call processor may itself already be actively operational to process calls other than those to be processed by the other (‘active’) call processor, thereby providing load sharing of the call processing functions. Where the backup call processor is on standby, it may be ready to serve as backup to only one other call processor, or alternatively to any one of a plurality of call processors in the event of failure.

In the following description it is assumed that the call processor 1 101 is in an active state and the call processor 2 102 is in a standby state ready to take over in place of the call processor 1 101 in the event of failure of the call processor 1 101 being detected.

The system 100 includes in its infrastructure further call processors, each of which may have a fixed location. Two such further processors are shown in FIG. 1, namely a base station 1 103 which operates to serve client terminals which are mobile stations in a given cell or geographical area defined by the position of the base station 1 103 and a base station 2 104 which operates to serve client terminals which are mobile stations in another given cell or geographical area defined by the position of the base station 2 104. Illustratively, mobile stations 115 and 116 served by the base station 1 103 by wireless communication with the base station 1 103 and mobile stations 117 and 118 served by the base station 2 104 by wireless communication with the base station 2 104 are shown in FIG. 1.

The cells in which mobile stations are served by the base station 1 103 and by the base station 2 104 may be a in a zone of the system 100 controlled by a zone controller comprising the call processor 1 101 and/or the call processor 2 102.

The call processor 1 101 and the call processor 2 102 may have a direct link 112 between them. In order to minimise the risk of failure of the direct link 112, the direct link 112 may be a link which itself has no active intermediate call processors. It may suitably be a ground based link formed for example of conducting wire or of optical fibre cable in a known manner, although it may alternatively be a wireless link such as a microwave link. The call processor 1 101 and the call processor 2 102 are able to communicate with one another via the direct link 112 using a communication protocol designed for inter-processor, e.g. inter-server, communication. The call processor 1 101 and the call processor 2 102 may operate a procedure to decide which of the two of them is to be active in the processing of certain specified calls, e.g. calls originating in the zone including the base station 1 103 and the base station 2 104, and to decide which is to serve as backup to the other. Only one of the two call processors 1 101 and 2 102 should be active at any one time. The roles of the call processor 1 101 and the call processor 2 102 when established respectively as active and backup may remain the same. Alternatively, the roles may be periodically reversed.

The functions of the call processor 1 101 when active thus include: (i) processing of calls originated by or to be received by the base station 1 103 on behalf of the mobile stations such as the mobile station 115 and the mobile station 116 that it serves; and (ii) processing of calls originated or to be received by the base station 2 104 on behalf of the mobile stations such as the mobile station 117 and the mobile station 118 that it serves. The call processor 1 101 may also process calls for other call processors which are base stations (not shown in FIG. 1) in the same zone as the base station 1 103 and the base station 2 104. The call processor 3 103 may also process calls to be established via call processors (not shown) in one or more other zones, e.g. zonal servers in such other zones, of the system 100.

The call processor 1 101 when active may perform one or more of the following activities in a known manner:
mobile station affiliation and de-affiliation (with the system 100 in the zone concerned);
mobile station authentication (to operate in the zone concerned);
air interface channel resource management;
call processing, call setup, and call termination;
routing of traffic (audio and data) call routing;
mobility management of mobile stations;
fault management reporting regarding connectivity to base stations and other call processing devices;
statistics gathering for performance management;
creation of data for billing or charging purposes.

In relation to the air interface channel resource management, the call processor 1 101 may for example allocate time slot traffic channels in accordance with the TETRA standard protocol.

A link 105 exists between the call processor 1 101 and the base station 1 103. The link 105 may include one or more wireless links which may possibly pass through one or more other intermediate processors (not shown). The link 105 may use the same or different communication channels for communication in the two different directions between the call processor 1 101 and the base station 1 103. Similarly, a link 106 exists between the call processor 2 102 and the base station 1 103. The link 106 may include one or more wireless links which may possibly pass through one or more other intermediate processors (not shown). The link 106 may use the same or different communication channels for communication in the two different directions between the call processor 2 102 and the base station 1 103.

A further link 107 exists between the call processor 1 101 and the call processor 2 102. The link 107 may include one or more wireless links which may pass through other intermediate processors (not shown). The link 107 may use the same or different communication channels for communication in the two different directions between the call processor 1 101 and the call processor 2 102. The link 107 and the link 106 may together form a standby link between the call processor 1 101 and the base station 1 103.

The link 105 and the link 106 preferably are different links which do not include common portions so that one of the links is likely to be able to operate normally in the event of failure of the other.

A link 109 exists between the call processor 1 101 and the base station 2 104. The link 109 may include one or more wireless links which may possibly pass through one or more other intermediate processors (not shown). The link 109 may use the same or different communication channels for communication in the two different directions between the call processor 1 101 and the base station 2 104. Similarly, a link 110 exists between the call processor 2 102 and the base station 2 104. The link 110 may include one or more wireless links which may possibly pass through one or more other intermediate processors (not shown). The link 110 may use the same or different communication channels for communication in the two different directions between the call processor 2 102 and the base station 2 104.

A further link 111 exists between the call processor 1 101 and the call processor 2 102. The link 111 may include one or more wireless links which may pass through other intermediate processors (not shown). The link 111 may use the same or different communication channels for communication in the two different directions between the call processor 1 101 and the call processor 2 102. The link 110 and the link 111 may together form a standby link between the call processor 1 101 and the base station 2 104.

The links 107 and 111 may be different links, as shown in FIG. 1, although they could be the same link.

The link 109 and the link 110 preferably are different links which do not include common portions so that one of the links is likely to be able to operate normally in the event of failure of the other.

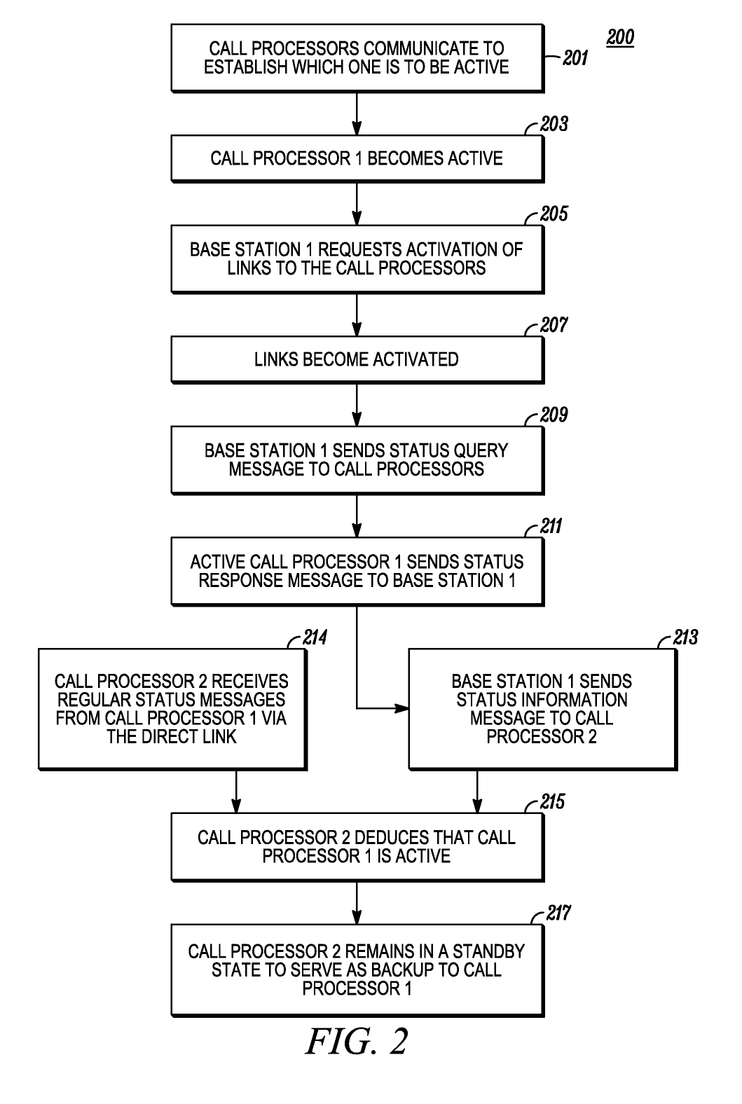

An illustrative method 200 of operation of the system 100 shown in FIG. 1 is depicted in FIG. 2. In a step 201, the call processor 1 101 and the call processor 2 102 communicate with one another via the direct link 112 to decide which of them is to be active in the zone of the system 100 in which they operate and to decide which of them is to serve as backup call processor to the other. Being active includes processing certain specified calls, including calls requested by the base station 1 103 on behalf of the mobile stations 115 and 116 and calls requested by the base station 2 104 on behalf of the mobile stations 117 and 118. Being active may also include one or more of the other call processor functions given earlier. Normally, the call processor 1 101 becomes the active processor as indicated in a step 203.

The base station 1 103 has two potential links to the active call processor 1 101. A main link can be provided by the link 105 and a standby (support) link can be provided by the link 106 and the link 107. The links 105, 106 may initially be activated only upon request by the base station 1 103, e.g. by a ‘Link Up Request’ message sent by the base station 1 103. The base station 1 103 may request activation of the links 105 and 106 in each of several situations, e.g. when the base station 1 103 has first powered on or has been re-set or has recovered after a system failure, or when previously activated links have been lost. The links 105, 106 and 107 may become activated by the base station 1 103 sending a query message in one direction and receiving a response message from the active call processor 1 101 (at least) in the other direction. A step 205 shown in FIG. 2 indicates the base station 1 103 requesting activation of the links 105, 106 and 107.

In a step 207, the links 105, 106 and 107 become activated in response to step 205.

In a step 209, the base station 1 103 sends one or more status query messages directed to the call processor 1 101 and the call processor 2 102 respectively via the link 105 and the link 106. Initially, the base station 1 103 may not be aware of which one of the two call processors, namely the call processor 1 101 and the call processor 2 102, is to be the active call processor to process calls requested by or to be received by the base station 1 103. Thus, the base station 1 103 may continue to send the status query messages until it receives a response from one of the call processors.

In a step 211, the active call processor 1 101 receives the status query message (or one of the status query messages) and in response sends a status response message (also referred to herein as a ‘status indication message’) to indicate that it is alive and active. It is not essential for the backup call processor 2 102 to respond to the status query message. However, the backup call processor 2 102 may also send in response to the status query message a status response message which indicates that it is alive and is in standby state and ready to serve as backup call processor to the active call processor 1 101.

In a particular embodiment of the method 200, for the first status query message sent by the base station 1 103 and the first status response message sent by the call processor 1 101, step 209 may be combined with step 205, and step 211 may be combined with step 207. Subsequent separate status query and response messages may be sent regularly, e.g. once every status interval (status indication period), where the status interval is selected according to the operational design of the system 100. The status interval may for example be in the range of from 0.3 seconds to 3 seconds, such as about 1 second. Thus, a status query message relating to the status of the call processor 1 101 may be sent, and a status response message in response may be expected, by the base station 1 103 in each of a series of such consecutive status intervals, e.g. every second where the status interval is one second.

In response to receiving each status response message from the active call processor 1 101, the base station 1 103 sends in a step 213 a status information message to the call processor 2 102 to indicate to the call processor 2 102 that the base station 1 has received from the call processor 1 101 the status response message indicating that the call processor 1 101 is alive. The status information message may also indicate that the call processor 1 is also active. In a step 214, the call processor 2 102 also receives from the call processor 1 101 via the direct link 112 regular status messages from the call processor 1 101 indicating that the call processor 1 101 is alive and is active. From the messages received in steps 213 and 214, the call processor 2 102 is able to deduce in a step 215 that the active call processor 1 101 is active and alive and is therefore operating normally. As indicated by a step 217, the call processor 2 102 thereby remains in its standby state to serve as backup to the active call processor 1 101.

A procedure similar to steps 207 to 217 of the method 200 involving the base station 2 104 may operate using the links 109, 110 and 111 when activated. In a step similar to step 209, the base station 2 104 may send status query messages directed to the call processor 1 101 and the call processor 2 102 respectively via the link 109 and the links 110 and 111. Initially, the base station 2 104 may not be aware of which one of the two call processors, namely the call processor 1 101 and the call processor 2 102, is to be the active call processor to process calls requested by the base station 2 104. Thus, the base station 1 104 may continue to send the status query messages until it receives a response from one of the call processors. In a step similar to step 211, the active call processor 1 101 receives the status query message (or one of the status query messages) and in response sends a status response message to indicate that it is alive and active. In response to receiving the status response message from the active call processor 1 101, the base station 2 104 may send in a step similar to step 213 a status information message to the call processor 2 102 to indicate to the call processor 2 102 that the base station 2 104 has received from the call processor 1 101 the status response message indicating that the call processor 1 101 is alive and active. In the step 214, the call processor 2 102 also receives from the call processor 1 via the direct link 112 status messages from the call processor 1 101 indicating that the call processor 1 101 is alive and is active. The call processor 2 102 is thereby able to deduce in a step similar to step 215 that the active call processor 1 101 is alive and active and is operating normally. The call processor 2 102 thereby remains in its standby state to serve as backup to the call processor 1 101.

In the method 200 described above, the call processors shown in FIG. 1 which obtain status information from the call processor 1 101 and provide status information to the call processor 2 102 (indicating that the call processor 1 101 is alive and active) are base stations, namely the base station 1 103 and the base station 2 104. In another embodiment, one or more other call processors, e.g. call processing servers (not shown) of the system 100, could obtain and provide this status information. The other call processing server(s) may for example be one or more zonal call processing servers associated with a zone controller in another zone of the system 100. The other call processing server(s) may for example be one or more call processing server(s) having to communicate with the call processor 1 101 when active in order to establish a call which extends between different zones of the system 100.

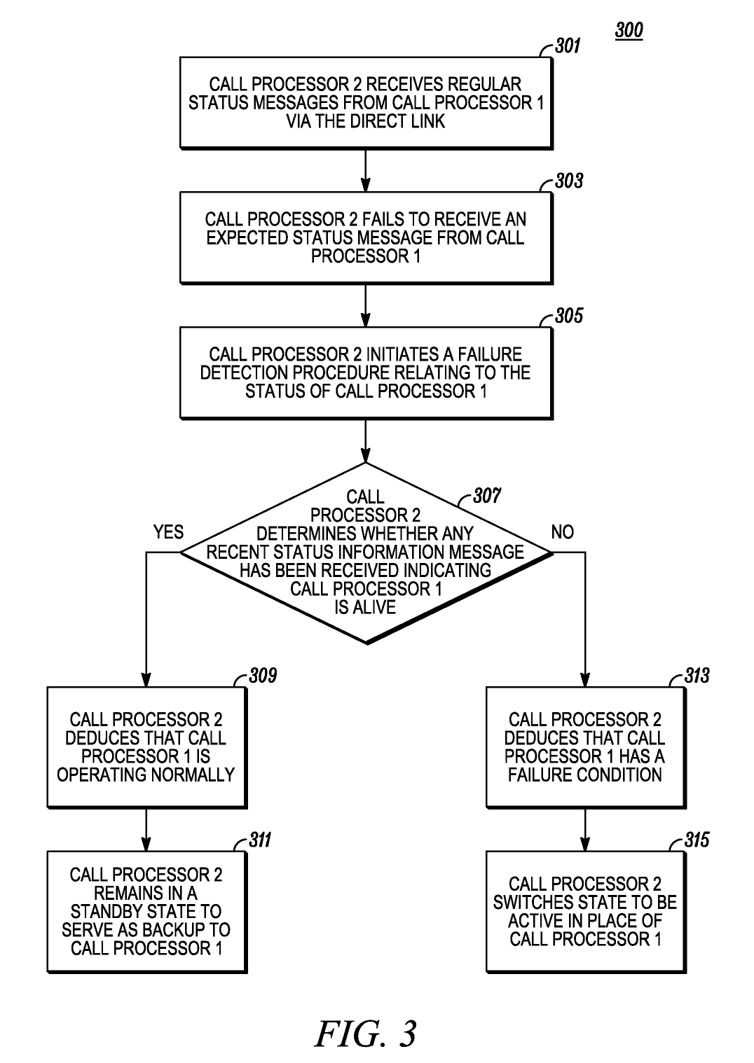

A further illustrative method 300 of operation in the system 100 is depicted in FIG. 3. The method 300 may be employed in conjunction with the method 200. As indicated by a step 301, the call processor 2 102 receives, direct from the call processor 1 101 via the direct link 112, regular status messages indicating that the status of the call processor 1 101 is alive and active. The frequency of the status messages (sent and received) may be one status message every status interval (status indication period). The status interval is selected according to operational design of the system 100. The status interval may for example be in the range of from 0.3 seconds to 3 seconds, such as about 1 second. Thus, a status message relating to the status of the call processor 1 101 may be expected by the call processor 2 102 in each of a series of such consecutive status intervals, e.g. every second where the status interval is one second.

Eventually, as indicated by a step 303, the call processor 2 102 may fail to receive an expected status message from the call processor 1 101 via the direct link 112 in a status interval. The expected status message may be the next expected one following a received status message in the previous status interval or it may be one after a delay period which is applied (following a status interval providing no received status message) to see whether receipt of the status messages is resumed within the delay period. Thus, a number of missed status messages may be allowed, e.g. a number in the range 1 to 10, e.g. 5 giving a delay of about 5 seconds.

In response to step 303, the call processor 2 102 initiates in a step 305 a failure detection procedure relating to the status of the call processor 1 101. The failure detection procedure is a secondary procedure applied to confirm the failure indication by the primary procedure (involving loss of communication) via the link 112. The call processor 2 102 determines in a step 307 of the failure detection procedure whether any recent status information has been received by the call processor 2 102 indicating that the call processor 1 101 is alive and active. The call processor 2 102 determines whether it is receiving one or more status messages normally indicating that the call processor 1 101 is alive and active. Such status messages may be status information messages which have been received from the base station 1 103, the base station 2 104 or any other base station or other call processor, e.g. call processing server of the system 100, which is enabled to indicate the status of the call processor 1 101 from status indication messages which it has received from the call processor 1 101. If the call processor 2 102 finds any one or more such messages which it has received, as indicated by the notation ‘YES’ in FIG. 3, the call processor 2 102 may deduce in a step 309 that the call processor 1 101 is alive and active and is operating normally.

In response to step 309, the call processor 2 102 remains in a standby state to serve as backup to the call processor 1 101, as indicated by a step 311. The call processor 2 102 may also try to re-establish communication with the call processor 1 101 via the direct link 112.

The call processor 2 102 may be unable in step 307 to find any status information messages which it has received normally, at least since the first missing status message in step 303, which would indicate that the call processor 1 101 is alive and active. Furthermore, the call processor 2 102 may receive, in the absence of status information messages, Link Up Requests from the base stations, e.g. the base station 1 103 and the base station 2 104. If the active call processor 1 101 develops a failure condition, the regular status query and status response messages sent between each of the base stations and the active call processor 1 101 may cease, and the links, e.g. links 105 and 107, to the active call processor 1 101 may thereby become inactive. In response, each base station may thereby send further Link Up Requests to try to re-activate the links. As noted earlier, the Link Up Requests will be sent to the backup call processor 2 102 as well as to the active call processor 1 101. The Link Up Requests may be sent repeatedly by each base station until a response is received. Thus, when the active call processor 1 101 has developed a failure, the backup call processor 2 102 receives status information indicating that the active call processor 1 101 is not alive by receiving Link Up requests, particularly repeated Link Up requests, from base stations (and other call processors) and no corresponding status information messages from the base stations and other call processors and no status messages direct from the call processor 1 101 via the direct link 112.

Since each of the call processor 1 101 and the call processor 2 102 may have a server-client relationship with each of the base stations, e.g. the base station 1 103 and the base station 2 104, it may not be possible for the backup call processor 1 102 to send to any of the base stations a confirmatory query about the status of the active call processor 1 101 during the application of step 307. However, a similar effect may be obtained in step 307 by the backup call processor 2 102 temporarily deactivating its links, e.g. the link 106 and the link 110, with the base stations. The temporary deactivation may be for a short period of time to cause the base stations to begin sending Link Up Requests and the active call processor 1 101 in response to send status response messages if it still alive and active. The temporary deactivation period is set sufficiently long to ensure that the base stations decide that the link to the active call processor has been lost and thereby try to re-establish the link by sending Link Up Requests. The temporary deactivation period depends on system operational design, but may for example be a period of between 1 and 5 seconds, e.g. about 1.5 seconds.

The backup call processor 2 102 may allow a delay period to see whether any information is received which indicates that the call processor 1 101 is alive and active. The delay period may depend on various operational factors within the system 100 such as a priority assigned in the system 100 to the call processors 1 101 and 2 102. Thus, the delay period may be shorter for a higher priority call processor.

If, as represented by the notation ‘NO’ in FIG. 3, the call processor 2 102 determines in step 307 that, despite any allowed delay, it has not received any information directly or indirectly indicating that the call processor 1 101 is alive, and/or has received information indicating that the call processor 1 101 is not alive, the call processor 2 102 deduces in a step 313 that the call processor 1 101 has a failure condition. In response to step 313, the call processor 2 102 switches its state to be active in place of the call processor 1 101, as indicated by a step 315. The call processor 2 102 then proceeds to carry out all of the same functions of the call processor 1 101 when active. The call processor 2 102 brings the database 114 into operation to support its activities in place of the database 113 supporting the call processor 1 101.

Active operation by the call processor 2 102 in place of the call processor 1 101 may continue until the call processor 2 102 receives a message indicating that the failure of the call processor 1 101 has been rectified and the call processor 1 101 is ready to be active again. The indication may for example be sent via the direct link 112 or one of the indirect links shown in FIG. 1. The method 200 may then be re-applied.

Alternatively, the call processor 2 102 may remain indefinitely as the active call processor and the call processor 1 101 when alive again may take over the role of backup to the call processor 2 102.

Each of the status query, status response and status information messages referred to above may be messages sent according to a ‘keep-alive’ protocol employed in the system 100. Thus, the device (e.g. base station or call processing server) receiving such a message understands the message according to the protocol. Each message may include an identity of the sending device.

Each of the call processors, namely the call processor 1 101 and the call processor 2 102 of the system 100, when active, and optionally when alive whether active or not, may have a bi-directional keep-alive communication with each of the base stations, namely the base station 1 103 and the base station 2 104. In such communications, each base station may periodically issue a status query message to the call processor and may expect a status response message, at least from the active call processor, in reply, as illustrated by steps 209 and 211 in FIG. 2.

In addition, the active call processor (at least) may periodically issue a status query message to the base station and expect a status response message in reply. If the base station receives no expected status query message and no expected status response message from the call processor which has previously indicated it was alive and active, the base station may attempt to re-establish an activated link via the active link and the standby link, e.g. by issuing a ‘Link Up Request’ as described earlier. If the active call processor receives no expected status query message and no expected status response message from each base station, via either the active link or the standby link with the base station, and the base station has previously indicated it was operating normally, the call processor may deduce that the base station has a failure condition. When the call processor makes that deduction it may assume that the base station is out of service, e.g. until the base station reports that is operating normally, e.g. via a Link Up Request. The call processor may also report the detected failure condition of the base station to a fault management receiver of the system 100, which may or may not be incorporated in a zone controller including the call processor.

By providing status information about the active call processor, e.g. the call processor 1 101 indirectly to the backup call processor, e.g. the call processor 2 102, by one or more intermediate call processors, e.g. the base station 1 103 or the base station 2 104, in one or more of the ways described above, the backup call processor is able to make a more informed decision as to whether to switch to an active state in place of the active call processor. Thus, the backup call processor is able to use the indirectly provided status information, including link requests sent to the backup call processor, in addition to that provided directly, e.g. via the direct link 112, to detect that the active call processor has a failure condition. Beneficially, this reduces the possibility of a false detection of a failure condition of the active call processor and the resulting unwanted event of both call processors becoming active at the same time when only one should be active.

Although the embodiments of the invention above have been described by reference to the system 100 being illustratively a TETRA system, the system 100 could alternatively be an APCO 25 system (operating in accordance with the APCO 25 standards) or a GSM system (operating in accordance with the GSM standards). In the latter case, the functions of the call processors 1 101 and 2 102 are carried out by MSCs (Mobile services Switching Centres).

1-16. (canceled)

17. A communication system comprising:
a first call processor;
a second call processor operable to serve as a backup to the first call processor in the event of a failure condition of the first call processor; and
a base station operable to communicate with the first call processor to establish a call on behalf of a client terminal served by the base station,
wherein the second call processor is operable to receive status information relating to the first call processor via a link with the first call processor,
wherein the base station is operable to receive a status indication from the first call processor indicating that it is alive, and
wherein the second call processor is operable to receive from the base station status information, obtained from the status indication, indicating that the first call processor is alive, and the second call processor is operable to use the status information from the base station to deduce that the first call processor is alive when no expected status information is received from the first call processor via its link with the first call processor.

18. A communication system according to claim 17, wherein:
the communication system is a mobile communication system, the first and second call processors and the base station are infrastructure components of the system, and
the base station is remote from the first and second call processors, and the first call processor is remote from the second call processor.

19. A communication system according to claim 17 further comprising at least one further base station operable to communicate with the first call processor to establish a call on behalf of a client terminal served by the at least one further base station, wherein the second call processor is operable to receive from the at least one further base station status information obtained from the first call processor indicating that the first call processor is alive and the second call processor is operable to use the status information from the at least one further base station to deduce that the first call processor is alive.

20. A communication system according to claim 19 wherein the base station, and the at least one further base station where present, is operable to send a status query message regularly to the first call processor and to receive from the first call processor when alive in response to each status query message a status indication message and in response to receiving each status indication message to send to the second call processor at least one status information message indicating the live status of the first call processor.

21. A communication system according to claim 20 wherein the status indication message and the status information message indicate that the first call processor is active as well as alive.

22. A communication system according to claim 21 wherein when the first call processor has a failure condition the third call processor, and the at least one further call processor where present, is operable to send repeated requests to re-establish a link to one of the first and second call processors and the second call processor is operable to receive the requests and to use the requests as status information about the first call processor and to deduce that the first call processor is not alive.

23. A communication system according to claim 22 wherein the first call processor is operable to receive status information relating to the second call processor via the link with the second call processor, wherein the base station, and the at least one further base station where present, is operable to receive from the second call processor when alive a status indication message indicating that the second call processor is alive and to send to the first call processor a status information message indicating that it has received the status indication message from the second call processor, whereby the first call processor can deduce the live status of the second call processor from the message sent by the base station or further base station when no expected status information is received from the second call processor via its link with the first call processor.

24. A communication system according to claim 23 wherein the first call processor and the second call processor have a direct link between them and the first call processor is operable to communicate a live status indication of the first call processor to the second call processor via the direct link.

25. A communication system according to claim 24 wherein the second call processor is operable to communicate a live status indication of the second call processor to the first call processor via the direct link.

26. A communication system according to claim 25 wherein the direct link has no intermediate processor and comprises a ground based direct cable or wire link or a direct wireless link.

27. A communication system according to claim 26 wherein the second call processor is operable to initiate, in relation to the first call processor, a failure detection procedure if it does not receive from the first call processor in at least one status indication period communication of a live status indication from the first call processor via the direct link.

28. A communication system according to claim 27 wherein the second call processor is operable to determine in the failure detection procedure whether it has received from a call processor other than the first call processor any recent status information indicating whether the first call processor is alive or not.

29. A communication system according to claim 28 wherein the failure detection procedure includes the second call processor temporarily deactivating its link with the third call processor and with the at least one further call processor where present.

30. A communication system according to claim 29 wherein the second call processor is operable to deduce that the first call processor has a failure condition if the second call processor has not received in an allowed period communication of a live status indication from the first call processor via the direct link and has received from at least one base station or call processor other than the first call processor: (i) no information indicating a live status of the first call processor; or (ii) information indicating a failure condition of the first call processor.

31. A communication system according to claim 30 wherein the second call processor is operable, upon deducing a failure condition of the first call processor, to become active in place of the first call processor in establishing calls on behalf of client terminals served by the at least one other call processor.

32. A communication system according to claim 17, wherein the communication system is a TETRA system, an APCO 25 system, or a GSM system.

33. A communication system according to claim 32 wherein the communication system is a TETRA system and the first and second call processors are call processing servers of zone controllers.
